(19) United States
(12) Patent Application Publication
(10) Pub. No.: US 2021/0197857 A1
(43) Pub. Date: Jul. 1, 2021

(54) SYSTEMS FOR CONTROLLING VEHICLES AND VEHICLES

(71) Applicant: SZ DJI TECHNOLOGY CO., LTD., Shenzhen (CN)

(72) Inventors: Jianyun MA, Shenzhen (CN); Jiahang YING, Shenzhen (CN); Zhimeng SHANG, Shenzhen (CN)

(73) Assignee: SZ DJI TECHNOLOGY CO., LTD., Shenzhen (CN)

(21) Appl. No.: 17/198,092

(22) Filed: Mar. 10, 2021

Related U.S. Application Data
(63) Continuation of application No. PCT/CN2019/080144, filed on Mar. 28, 2019.

(51) Int. Cl. B60W 60/00; B60R 16/023; B60W 50/00; G05D 1/00

(52) U.S. Cl. CPC B60W 60/005; B60R 16/0231; G05B 15/02; G05D 1/0061; B60W 2050/0043; B60W 50/0098

(57) ABSTRACT

The present disclosure provides a system for control a vehicle and a vehicle. The system includes: a control module configured to electrically connect to a control bus of a vehicle, the control module including: one or more storage media storing one or more sets of instructions for controlling a vehicle; and one or more processors, during operation, to execute the one or more sets of instructions to: receive a bus signal from the control bus, query a type of a control signal according to the bus signal, and convert-to-analog a control output signal for the vehicle according to a result of the query to control a driving state of the vehicle.

### RELATED APPLICATIONS

The present patent document is a continuation of PCT Application Serial No. PCT/CN2019/080144, filed on Mar. 28, 2019, designating the United States and published in Chinese, content of which is herein incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### 1. Technical Field

The present disclosure relates to the field of automated driving, and in particular, to systems for controlling vehicles and vehicles.

### 2. Background Information

Currently, an automated driving system of a vehicle requires an additional control system in addition to a control network of the vehicle. However, a communication protocol of the control network of the vehicle is confidential before its delivery. Therefore, if the additional control system needs to be connected to the control network, the communication protocol needs to be decrypted. However, the decryption process is quite resource-intensive. In addition, a fault code would easily occur in the decryption process, that is, the control network cannot be accurately decrypted. In this case, there is often an error in information exchange between the additional control system and the control network of the vehicle, resulting in lower safety during the automatically operated driving of the vehicle.

### BRIEF SUMMARY

This summary is provided to introduce a selection of implementations in a simplified form that are further described below. This summary is not intended to identify all features of the claimed subject matter, nor is it intended to be used alone as an aid in determining the scope of the claimed subject matter.

In order to solve the aforementioned technical problems, a system for controlling a vehicle with simple operation and high safety is provided.

A first aspect of embodiments of the present disclosure provides a system for controlling a vehicle. The system comprises: a control module configured to electrically connect to a control bus of a vehicle, the control module including: one or more storage media storing one or more sets of instructions for controlling a vehicle; and one or more processors, during operation, to execute the one or more sets of instructions to: receive a bus signal from the control bus, query a type of a control signal according to the bus signal, and convert-to-analog a control output signal for the vehicle according to a result of the query to control a driving state of the vehicle.

A second aspect of embodiments of the present disclosure provides a vehicle comprising the system according to the first aspect.

Compared with the conventional techniques, when the system for controlling a vehicle of the present invention executes the automatic operation driving mode, the control of each functional module of the vehicle can be done without the need to decode and analyze the information protocol in the vehicle's own operating system at all, such that the execution unit of the vehicle can perform the driving operation accurately, which simplifies the complexity of the automatic operation of the vehicle. At the same time, the vehicle control system in this application performs control based on the original control signal in the vehicle, thereby ensuring the accuracy and safety of vehicle control.

### BRIEF DESCRIPTION OF THE DRAWINGS

To describe the technical solutions in embodiments of the present disclosure more clearly, the following briefly describes the accompanying drawings that need to be used in the embodiments. Apparently, the accompanying drawings in the following description show merely some embodiments of the present disclosure, and a person of ordinary skill in the art may derive other drawings from these accompanying drawings without creative efforts.

FIG. 1 is a circuit structure diagram of a system for control a vehicle according to exemplary embodiments of the present disclosure;

FIG. 2 is a waveform diagram of each of a first sensing differential signal and a second sensing differential signal according to exemplary embodiments of the present disclosure;

FIG. 3 is a schematic diagram of a circuit structure of a power supply unit, a second switch unit, and a second execution module shown in FIG. 1;

FIG. 4 is a schematic flowchart of a conventional gear shifting strategy according to exemplary embodiments of the present disclosure;

FIG. 5 is a function block diagram of a vehicle including a system for control a vehicle according to exemplary embodiments of the present disclosure;

FIG. 6 is a schematic structural diagram of a gearbox in a first execution unit according to exemplary embodiments of the present disclosure; and

FIG. 7 is a schematic structural diagram of a connection between an oil pump and a hydraulic coupler in a first execution unit according to exemplary embodiments of the present disclosure.

### DETAILED DESCRIPTION OF THE DRAWINGS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by persons of ordinary skill in the art based on the embodiments of the present disclosure without creative efforts shall fall within the protection scope of the present disclosure.

It should be noted that, when a component is described as “fixed” to another component, the component may be directly located on another component, or an intermediate component may exist therebetween. When a component is considered as “connected” to another component, the component may be directly connected to another element, or an intermediate element may exist therebetween.

Unless otherwise defined, meanings of all technical and scientific terms used in this specification are the same as those generally understood by persons skilled in the art of the present disclosure. The terms used in this specification of the present disclosure herein are used only to describe specific embodiments, and not intended to limit the present disclosure. The term “and/or” used in this specification includes any or all possible combinations of one or more associated listed items.

The following describes in detail some implementations of the present disclosure with reference to the accompanying drawings. Under a condition that no conflict occurs, the following embodiments and features in the embodiments may be mutually combined.

The terminology used herein is for the purpose of describing particular exemplary embodiments only and is not intended to be limiting. When used in this disclosure, the terms “comprise”, “comprising”, “include” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some exemplary embodiments, numbers expressing quantities or properties used to describe or define the embodiments of the present disclosure should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in some exemplary embodiments, the numerical parameters set forth in the written description and the appended claims are approximations, which may vary depending upon the desired properties sought to be obtained in a particular embodiment. In some exemplary embodiments, numerical parameters should be interpreted in accordance with the value of the parameters and by applying ordinary rounding techniques. Although a number of embodiments of the present disclosure provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the technical solution in this application in accordance with the embodiments of the present disclosure. Therefore, the embodiments of the present disclosure are not limited to those embodiments that have been precisely described in this disclosure.

The technical solutions in the embodiments of the present disclosure are clearly and completely described below with reference to the accompanying drawings in the embodiments of the present disclosure. The described embodiments are merely some rather than all of the embodiments of the present disclosure. All other embodiments obtained by a person of ordinary skill in the art based on the embodiments of the present disclosure without creative efforts fall within the protection scope of the present disclosure.

Exemplary embodiments of the present disclosure disclose a system for control a vehicle. The system for control a vehicle may also be applied to a vehicle or other transportations.

The system for control a vehicle may include a control module that is to electrically connect to a control bus of the vehicle and configured to receive a bus signal from the control bus. The control module may include one or more storage media storing one or more sets of instructions for controlling the vehicle, and one or more processors. The one or more processors may be configured to: query a type of the bus signal according to the bus signal, and convert-to-analog a control output signal for the vehicle according to a result of the query, to control the vehicle to be operated by a driver or in an automated driving mode.

In some exemplary embodiments, the control module may be a general-purpose computer or a special purpose computer, both may be used to implement an on-demand system for the present disclosure. The control module may be used to implement any component of the on-demand service as described herein. Although only one such computer is shown, for convenience, the computer functions relating to the on-demand service as described herein may be implemented in a distributed fashion on a number of similar platforms, to distribute the processing load.

The control module, for example, may include COM ports connected to and from a network connected thereto to facilitate data communications. The control module may also include a central processing unit (CPU), in the form of one or more processors, for executing program instructions. The exemplary computer platform may include an internal communication bus, program storage and data storage of different forms, for example, a disk, and a read-only memory (ROM), or random-access memory (RAM), for various data files to be processed and/or transmitted by the computer. The exemplary computer platform may also include program instructions stored in the ROM, RAM, and/or other types of non-transitory storage medium to be executed by the CPU. The methods and/or processes of the present disclosure may be implemented as the program instructions. The control module also includes an I/O component, supporting input/output between the computer and other components therein such as user interface elements. The control module may also receive programming and data via network communications.

Merely for illustration, only one CPU and/or processor is described in the control module. However, it should be note that the control module in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the control module executes both step A and step B, it should be understood that step A and step B may also be performed by two different CPUs and/or processors jointly or separately in the control module (e.g., the first processor executes step A and the second processor executes step B, or the first and second processors jointly execute steps A and B).

In some exemplary embodiments of the present disclosure, the controlling of a driving state of the vehicle may include: converting-to-analog a signal of the type corresponding to the result of the query, and outputting the signal to a corresponding execution unit.

In some exemplary embodiments of the present disclosure, the converting-to-analog of the signal of the type corresponding to the result of the query may include: converting-to-analog the signal of the type corresponding to the result of the query so that the signal has a same waveform, voltage amplitude, and frequency as a control signal obtained during the query.

In some exemplary embodiments of the present disclosure, the control signal may include a transmitted vehicle sensor signal and/or a vehicle status signal.

In some exemplary embodiments of the present disclosure, the bus signal is used for representing whether the vehicle is operated by the driver or in the automated driving mode, and the control bus for transmitting the control signal may include a status signal bus electrically connected to a vehicle alert module and/or a sensor bus electrically connected to a sensor unit.

In some exemplary embodiments of the present disclosure, the control module may prestore a plurality of control signals for representing that the vehicle is in different driving states.

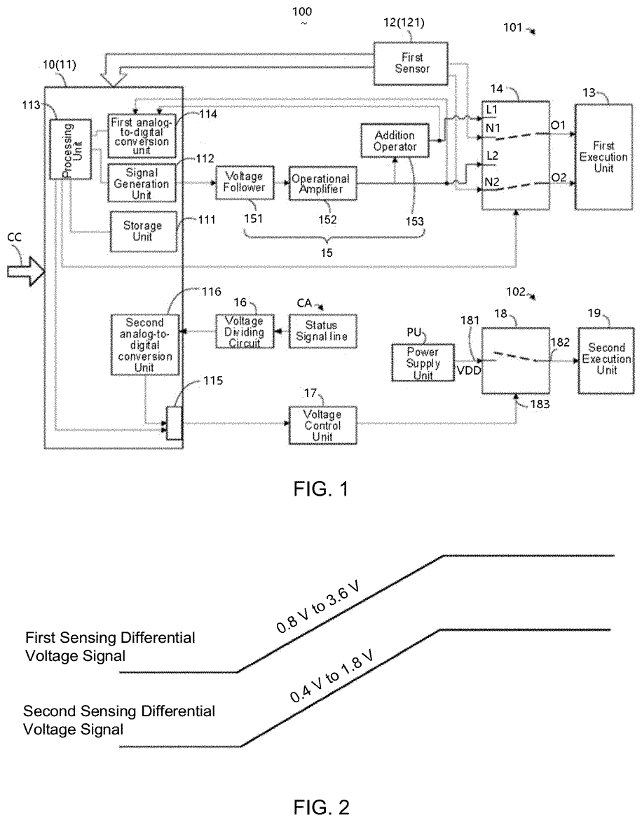

FIG. 1 is a circuit structure diagram of a system 100 for controlling a vehicle according to an embodiment of the present disclosure.

As shown in FIG. 1, the system 100 for controlling a vehicle may include a control module 10, a first subsystem 101, and a second subsystem 102. The first subsystem 101 and the second subsystem 102 may be electrically connected to the control module 10 separately. Each of the first subsystem 101 and the second subsystem 102 may obtain a different type of sensor signal or status signal according to the control signal. In some exemplary embodiments, the first subsystem 101 may be configured to obtain a sensor signal collected by a sensing module through sensing, and the second subsystem 102 may be configured to obtain a signal for controlling the vehicle to perform an alert operation.

A control bus CC may be configured to transmit a mode signal that is provided by a master control system (not shown) and used for representing that a vehicle needs to be in an automatically operated driving mode or a manually operated driving mode. In some exemplary embodiments, the vehicle control bus may be a controller area network (CAN) bus. The CAN bus may be a type of bus that encrypts transmitted data. Therefore, an external system usually needs to decipher a transmitted signal in the CAN bus, and then controls an execution mechanism of the vehicle according to information obtained through the deciphering. However, for different manufacturers and different types of vehicles, the bus may be encrypted in different manners. The use of the deciphering manner increases software costs. In addition, deciphering may generate a fault code and cause a packet loss, which may easily cause loss of a transmission instruction of the bus or returning of the fault code, resulting in an execution failure.

The first subsystem 101 may include a sensor unit 12, an execution unit 13, a first switch unit 14, and an analog unit 15. Corresponding to the first subsystem 101, the control module 10 may include an analog control processor 11.

The analog control processor 11 may be electrically connected to the control bus CC of the vehicle, the analog unit 15, and the first switch unit 14. The sensor unit 12 and the analog unit 15 may be electrically connected to the execution unit 13 through the first switch unit 14. Under the control of the analog control processor 11 according to the mode signal, the first switch unit 14 may cause the sensor unit 12 to be electrically connected to the execution unit 13 or cause the analog unit 15 to be electrically connected to the execution unit 13. The signal transmitted by the control bus CC of the vehicle may be directly inputted to the sensor unit 12 through transparent transmission or pass-through. Transparent transmission means that to-be-transmitted service content will only be transmitted from a source address to a destination address without any change to data of the service content and regardless of how the service content in communication is. In this case, a sensor is responsible only for receiving a control signal from the control bus of the vehicle, and does not need to decipher the signal, thereby avoiding a packet loss and a large number of fault codes. By collecting the signal of the control bus CC of the vehicle, an analog signal waveform(s) output by the control bus CC may be obtained, and each of the analog signal waveform(s) may correspond to a different type of control signal. The type of the control signal may be determined by the waveform and an amplitude value of the analog signal. For example, a signal output by a steering wheel is a continuous analog differential signal, and an amplitude value of this signal is related to a trigonometric function value of a rudder angle of the steering wheel. For another example, a signal output by a throttle is a continuous analog differential signal, and an amplitude value of this signal is related to a stroke function of a throttle pedal. For another example, a signal output by a brake is also a continuous analog differential signal, and an amplitude value of this signal is related to a stroke function of the brake. In some exemplary embodiments, amplitude values of output signals of different vehicles may be different. For example, a relationship between a direction angle and an output voltage of an A-type vehicle may be expressed by using the following formula:

V_{A}=a*f(bθ+c)+d

where f(θ) is a trigonometric function related to an angle θ, and a, b, c, and d are correction coefficients of the function. The correction coefficients may be used to correct output voltages of different types of vehicles.

For different types of vehicles, a correspondence between the rudder angle and the output voltage may be collected in advance to obtain specific correction values of a, b, c, and d. As shown in FIG. 1, the sensor unit 12 may include at least one first sensor 121, which may be configured to sense one of driving states of the vehicle and output a first sensing signal. In some exemplary embodiments, the first sensor 121 may be a throttle position sensor, which may be configured to sense a throttle pedal stroke distance. The first sensing signal may be configured to represent a fuel amount and a vehicle speed that need to be provided currently.

In some exemplary embodiments, the first sensing signal may include a first sensing differential signal and a second sensing differential signal. In some exemplary embodiments, both the first sensing differential signal and the second sensing differential signal may be differential voltage signals, and a second voltage range of the second sensing differential signal may be greater than and/or includes a first voltage range of the first sensing differential signal.

FIG. 2 is a waveform diagram of each of the first sensing differential signal and the second sensing differential signal. The first sensing differential signal and the second sensing differential signal each may have different voltage ranges. For example, the first voltage range may be 0.4 V to 1.8 V, and the second voltage range may be 0.8 V to 3.6 V. The sensor unit 12 shown in FIG. 1 may obtain both the first sensing differential signal and the second sensing differential signal, and determine, according to amplitude values and waveforms of the first sensing differential signal and the second sensing differential signal, the control signal transmitted by the control bus CC.

Still referring to FIG. 1, the analog control processor 11 may query, according to the mode signal provided by the control bus CC of the vehicle, signals corresponding to different types of signal buses. In some exemplary embodiments, the analog control processor 11 may query a first sensing signal in sensor-type signals, and outputs a reference signal to the analog unit 15 according to the result of the query. The analog unit 15 may convert-to-analog the first sensing signal according to the reference signal to output a first analog signal. The first analog signal may have a same changing curve as the sensing signal.

In some exemplary embodiments, the analog control processor 11 may query an entire first sensing signal formed by the two differential signals, i.e., the first sensing differential signal and the second sensing differential signal, and obtain, by querying a prestored signal waveform, a signal type shown by the first sensing signal.

In some exemplary embodiments, the analog control processor 11 may include a storage unit 111, a signal generation unit 112, a processing unit 113, and a first analog-to-digital conversion unit 114. The storage unit 111 may store a sensor signal list including a plurality of first sensing signals. The plurality of first sensing signals may be sensor signals prestored according to a plurality of states of the throttle pedal stroke that are collected in advance by the first sensor 121.

The processing unit 113 may be electrically connected to the storage unit 111 and the signal generation unit 112 separately. The processing unit 113 may receive the mode signal, and output a corresponding selection signal to the first switch unit 14 according to the mode signal. The mode signal may be configured to represent that the vehicle currently needs to be in the automatically operated driving mode or the manually operated driving mode. In addition, the mode signal may be provided by a corresponding person outside the vehicle, or may be provided by a corresponding function module triggered by detection and recognition by a sensor module corresponding to the vehicle. In some exemplary embodiments, when the mode signal is at a high level, it represents the automatically operated driving mode, and when the mode signal is at a low level, it represents the manually operated driving mode.

After the mode signal controls the vehicle to enter the automatically operated driving mode, the processing unit 113 may no longer be controlled by the transparently transmitted signal of the vehicle control bus CC, but instead, be controlled by a control signal of a driving system. The control signal of the driving system may be partially from the control bus CC of the vehicle. In addition, the control signal of the driving system may be from a vehicle sensor, or a logical processor that generates a vehicle control signal according to the vehicle sensor. According to a type of a received signal, the processing unit 113 searches the sensor signal list for the first sensing signal corresponding to the type of the received signal, and convert-to-analog the first sensing signal to generate the first analog signal. The first analog signal controls the first execution unit 13 to perform a corresponding operation. In other words, the processing unit 113 controls, according to the first sensing signal obtained through the query, the signal generation unit 112 to output a corresponding reference signal. Further, the analog unit 15 may convert-to-analog the first sensing signal according to the reference signal to generate the first analog signal.

The first analog signal may include a first analog differential signal and a second analog differential signal. In some exemplary embodiments, both the first analog differential signal and the second analog differential signal may be differential voltage signals. The first analog differential signal may correspond to the first sensing differential signal, and the second analog differential signal may correspond to the second sensing differential signal. The first and second analog differential signals may be input to an execution unit to control the vehicle. The execution unit may include various different types of executors, capable of controlling a rudder angle of a turning direction of the vehicle, controlling a gear of the vehicle, controlling the throttle and an engine speed of the vehicle, and the like.

The first analog signal may include a first analog differential signal and a second analog differential signal. The first analog differential signal may have a same changing curve as the first sensing differential signal. The second analog differential signal may have a same changing curve as the second sensing differential signal. Having a same changing curve may include having a same waveform, voltage amplitude, and frequency.

When the mode signal represents that the vehicle currently needs to be in the manually operated driving mode, the processing unit 113 may control the first sensing signal that is correspondingly obtained by the sensor unit 12 through sensing according to a driver operation to be directly output to the first execution unit 13.

In some exemplary embodiments, the signal generation unit 112 may be a pulse width modulation (PWM) signal circuit, and a reference signal output by the circuit may be a pulse width modulation signal with a certain duty cycle. Corresponding first analog signals may be generated in cooperation with the analog unit 15 by outputting, corresponding to different first sensing signals, pulse width modulation signals with different duty cycles as reference signals.

The first analog-to-digital conversion unit 114 may be electrically connected to the first sensor 121, the first switch unit 14, and the processing unit 113.

In some exemplary embodiments, the first analog-to-digital conversion unit 114 may be electrically connected to two normally open input contacts of a relay in the first switch unit 14, to receive the first analog differential signal and the second analog differential signal that are fed back, perform analog-to-digital conversion to convert the first analog differential signal and the second analog differential signal into digital signals, and provide the digital signals to the processing unit 113. The processing unit 113 may adjust the pulse width modulation signal according to the first analog differential signal and the second analog differential signal that are fed back, so that each of the first analog differential signal and the second analog differential signal may be within a preset range.

Further, the first analog-to-digital conversion unit 114 may be electrically connected to the first sensor 121, to receive the first sensing differential signal and the second sensing differential signal that are fed back, perform analog-to-digital conversion to convert the first sensing differential signal and the second sensing differential signal into digital signals, and provide the digital signals to the processing unit 113. The processing unit 113 may determine a state of the first driving module according to the digital version of the first sensing differential signal and the second sensing differential signal, and perform an operation in the automatically operated driving mode or exits the automatically operated driving mode according to the state of the first driving module.

The analog unit 15 may include a voltage follower 151, an operational amplifier 152, and an addition operator 153 that are sequentially electrically connected.

The voltage follower 151 may be electrically connected between the signal generation unit 112 and the operational amplifier 152, and may be configured to receive the reference signal, to further perform, before the operational amplification is performed on the pulse width modulation signal, voltage following on the pulse width modulation signal so as to isolate the operational amplifier from interference.

The operational amplifier 152 may be electrically connected to the voltage follower 151 and the addition operator 153 separately. After receiving the pulse width modulation signal, the operational amplifier 152 may perform the operational amplification on the received pulse width modulation signal, and then the pulse width modulation signal may be converted into an analog voltage signal. The analog voltage signal may have a first voltage range. The analog voltage signal may be transmitted to the first switch unit 14 as the first analog differential signal.

The addition operator 153 may be electrically connected to the first switch unit 14, and may be configured to perform an addition operation on the first analog differential signal according to a preset reference voltage range to obtain a second voltage range as the second analog differential signal, and transmit the second analog differential signal to the second switch unit 12.

The first switch unit 14 is electrically connected to the analog unit 15, the sensor unit 12, and the execution unit 13, and may be configured to: according to a selection signal output by the analog control processor 11, selectively electrically connect the analog unit 15 to the execution unit 13 or electrically connect the sensor unit 12 to the execution unit 13. The execution unit 13 may be configured for a driving operation of the vehicle. The sensor unit 12 and the analog unit 15 may not be simultaneously electrically connected to the execution unit 13.

In some exemplary embodiments, the first switch unit 14 is a double-pole double-throw relay (not shown), and the relay may include two normally closed input contacts L1 and L2, two normally open input contacts N1 and N2, and two output terminals O1 and O2.

The two normally closed input contacts L1 and L2 of the relay may be electrically connected to the first sensor 121, to receive the first sensing differential signal and the second sensing differential signal in the first sensing signal.

The two normally open input contacts N1 and N2 of the relay may be respectively electrically connected to the operational amplifier 152 and the addition operator 153 in the analog unit 15, to receive the first analog differential signal and the second analog differential signal in the first analog signal.

The analog control processor 11 controls the two output terminals O1 and O2 of the relay to be electrically connected to the execution unit 13, to selectively control the first sensing signal or the first analog signal to the execution unit 13 according to the selection signal.

When the selection signal is at a high level, it represents that the vehicle is in the automatically operated driving mode, and under control of the low level, the two normally open input contacts N1 and N2 and the two output terminals O1 and O2 of the relay may be electrically connected. In other words, when the analog unit 15 is electrically connected to the execution unit 13, the first sensing signal is transmitted to the execution unit 13 by using the relay, and the execution unit 13 performs the corresponding driving operation according to the first sensing signal, for example, according to an operation performed by the driver on the throttle pedal, increases a pedal force on the throttle pedal to increase the vehicle speed or decreases the pedal force on the throttle pedal to decrease the vehicle speed.

When the selection signal is at a low level, it represents that the vehicle is in the manually operated driving mode and operated by the driver, and under control of the low level, the two normally closed input contacts L1 and L2 and the two output terminals O1 and O2 of the relay may be electrically connected. In other words, when the sensor unit 12 is electrically connected to the execution unit 13, it represents that the vehicle is in the automatically operated driving mode, and the first analog signal is transmitted to the execution unit 13 through the relay, and the execution unit 13 performs the corresponding driving operation according to the first analog signal. For example, the execution unit 13, according to a current vehicle condition and a road condition directly, automatically increases a pedal force on the throttle pedal to increase the vehicle speed or decreases the pedal force on the throttle pedal to decrease the vehicle speed.

Since the control module 10 and the analog unit 15 may be connected to the normally open input contacts of the relay, when the control module 10 cannot correctly output the first analog signal because a signal transmission exception or a power failure occurs in the control module 10, it can be ensured that the sensor unit 12 of the normally closed input contact of the relay can be reliably electrically connected to the first execution unit 13, thereby ensuring that the first sensing signal is reliably provided to the first execution unit 13 so that the first execution unit 13 correctly performs the corresponding operation and ensures safe driving of the vehicle.

In a modified embodiment of the present disclosure, the first switch unit 14 is a multiway digital switch. The multiway digital switch may include at least two groups of input ports and at least one group of output ports. The two groups of input ports may not be simultaneously electrically connected to the output port group. Each group of input ports may include two input ports. Each group of output ports may include two output ports. Two input ports in one group may be electrically connected to the first sensor, to receive the first sensing differential signal and the second sensing differential signal in the first sensing signal. Two input ports in another group may be electrically connected to the analog control unit, to receive the first analog differential signal and the second analog differential signal in the first analog signal.

The analog control processor 11 may control the two input ports to be connected to the first execution unit 13, to selectively provide the first sensing signal or the first analog signal to the first execution unit 13.

In some exemplary embodiments of the present disclosure, the first sensor 121 may be a steering wheel sensor configured to sense the position of a steering wheel when it turns, a brake sensor configured to sense the position of a brake during a braking stroke, a door lock sensor configured to sense a door lock position, or a gear sensor configured to sense a gear position, so as to correspondingly output the first sensing signal.

The analog control processor 11 may be electrically connected to the vehicle control bus CC, and may be configured to obtain the bus signal.

A working process of the first subsystem 101 may be specifically as follows.

When the mode signal is at the low level, it represents that currently the vehicle is in the manually operated driving mode. The processing unit 113 may output the selection signal to the first switch unit 14, to control the two normally closed input contacts L1 and L2 and the two output terminals O1 and O2 thereof to be electrically connected, so that the sensor unit 12 is electrically connected to the first execution unit 13. In other words, during the manual operation, the first sensing signal obtained by the sensor unit 12 through sensing may be directly transmitted to the first execution unit 13, to implement manually operated driving of the vehicle.

When the mode signal is at the high level, it represents that currently the vehicle is in the automatically operated driving mode. The processing unit 113 may output the selection signal to the first switch unit 14, to control the two normally open input contacts N1 and N2 and the two output terminals O1 and O2 to be electrically connected, so that the analog unit 15 is electrically connected to the first execution unit 13. In addition, the processing unit 113 may query the storage unit 111 for a first sensing signal meeting a current road condition. The signal generation unit 112 may output a pulse width modulation signal with a corresponding duty cycle to the analog unit 15. Corresponding to the pulse width modulation signal, the analog unit 15 may obtain the first analog differential signal and the second sensing differential signal in the first analog signal through isolation processing by the voltage follower 151 and the amplification and addition operation by the operational amplifier 152 and the addition operator 153.

The analog unit 15 may output the first analog signal to the first execution unit 13, so that the control module 10 automatically controls the first execution unit 13.

Further, the second subsystem 102 may include a voltage dividing circuit 16, a voltage control circuit 17, a second switch unit 18, and a second execution unit 19, and a power supply unit PU. In addition, the analog control processor 11 may further include a second analog-to-digital conversion unit 116 and a first output unit 115. The voltage dividing circuit 16 may be electrically connected between a status signal line CA and the second analog-to-digital conversion unit 116. The voltage control circuit 17 may be electrically connected between the first output unit 115 and the second switch unit 18. In addition, the processing unit 113 may be electrically connected to the first output unit 115.

The power supply unit PU may be electrically connected to the second switch unit 18 and the second execution unit 19. In some exemplary embodiments, the first output unit 115 may be an input/output pin GPIO of a chip.

The voltage dividing circuit 16 may be electrically connected to the status signal line CA, and may be configured to receive a status signal transmitted by the status signal line CA, for example, a signal for controlling the vehicle to perform an alert operation. In some exemplary embodiments, the status signal line CA may be a left turn signal harness. The voltage dividing circuit 16 may be configured to identify a voltage state of the status signal, that is, configured to identify whether the status signal is currently at a high voltage or a low voltage, correspondingly output, according to the high voltage or the low voltage of the status signal, an identification voltage signal that has a same waveform and amplitude as the status signal, and transmit the identification voltage signal to the second mode conversion unit 116. In addition, the storage unit 111 may further prestore the status signal.

The second analog-to-digital conversion unit 116 may perform analog-to-digital conversion to convert the identification voltage signal into a digital signal, and output the digital signal through the first output port 115.

The voltage control circuit 17 is electrically connected to the first output unit 115, and may be configured to receive the identification voltage signal and accordingly output a second control signal. In some exemplary embodiments, when the identification voltage signal is at the first voltage, a second control sub-signal in a first voltage state may be output; and when the identification voltage signal is at the second voltage, a second control sub-signal in a second voltage state may be output.

In some exemplary embodiments, when the first voltage is at a high level, the first voltage state may be a high level, and when the second voltage is at a low level, the second voltage state may be a low level.

The second switch unit 18 may include a first connection terminal 181, a second connection terminal 182, and a control terminal 183. The first connection terminal 181 and the second connection terminal 182 may be selectively electrically connected or electrically disconnected according to a voltage of the control terminal 183. The first connection terminal 181 may be electrically connected to the power supply unit PU, to receive a first driving voltage VDD. The second connection terminal 182 may be electrically connected to the second execution unit 19. The control terminal 183 may be electrically connected to the voltage control circuit 17 in the analog control unit 11.

In some exemplary embodiments, the second switch unit 18 may be a single-pole single-throw relay. The first connection terminal 181 may be a normally open terminal of the relay. The second connection terminal 182 may be an output terminal of the relay. The control terminal 183 may be a power terminal of the relay. When the second control signal is at a high level, the relay may be powered to be in a closed state, and the first connection terminal 181 may be electrically connected to the second connection terminal 182. When the second control signal is at a low level, the relay may be powered to be in an off state, and the first connection terminal 181 may be electrically disconnected from the second connection terminal 182.

When the first connection terminal 181 is electrically connected to the second connection terminal 182, the first driving voltage VDD may be transmitted to the second execution module 19, and the second execution module 19 may perform a first alert operation, so that the vehicle is in a first alert state. When the first connection terminal 181 is electrically disconnected from the second connection terminal 182, the transmission of the first driving voltage VDD to the second execution module 19 may be stopped.

In some exemplary embodiments, the first alert operation may be a left turn alert or a right turn alert of the vehicle, the first alert state may be that a left turn signal is turned on or a right turn signal is turned on, and the second execution unit 19 may be the left turn signal or the right turn signal.

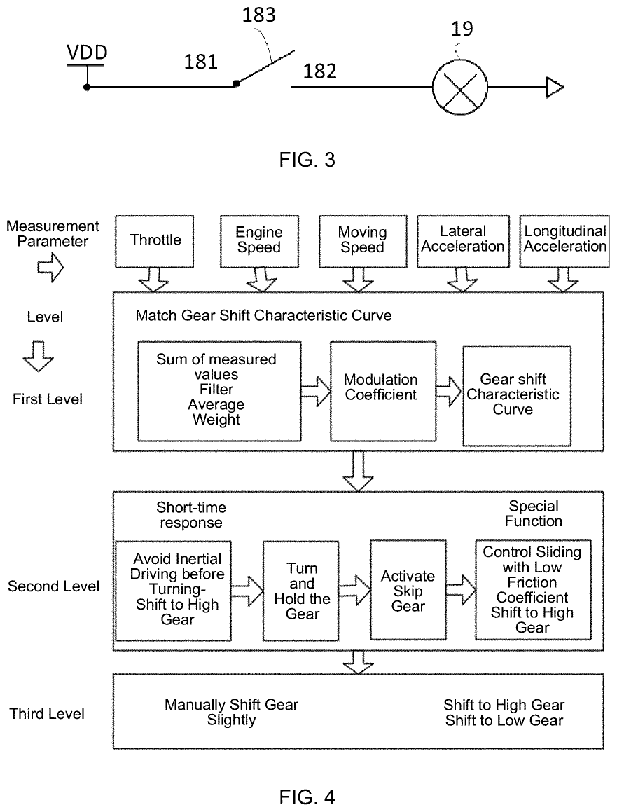

In some exemplary embodiments, referring to both FIG. 1 and FIG. 3, FIG. 3 is a simplified schematic diagram of a circuit of the power supply unit PU, the second switch unit 18, and the second execution module 19.

When the first connection terminal 181 is electrically connected to the second connection terminal 182, the first driving voltage VDD may be transmitted to the second execution module 19, and the second execution module 19 may be in an execution state of an alert operation, that is, the left turn signal may be turned on. When the second control sub-signal is in the second voltage state, the first connection terminal 181 may be electrically disconnected from the second connection terminal 182, the transmission of the first driving voltage VDD to the second execution module 19 may be stopped, and the second execution module 19 may be in an execution state of a non-alert operation, that is, the left turn signal may be turned off. In some exemplary embodiments, the first driving voltage VDD may be 12 V.

In some exemplary embodiments, the first alert operation may be a door lock control alert, an ignition switch control alert, an emergency flasher control alert, a low beam headlamp alert, a width lamp alert, a front fog lamp alert, a rear fog lamp alert, or a high beam headlamp alert. The first alert state may be that lock control, ignition switch control, emergency flasher control, a low beam headlamp, a width lamp, a front fog lamp, a rear fog lamp, or a high beam headlamp is activated. Correspondingly, the second execution module may be a door lock, an ignition switch, an emergency flasher, the low beam headlamp, the width lamp, left and right turn signals, the front fog lamp, the rear fog lamp, or the high beam headlamp.

In some exemplary embodiments of the present disclosure, the status signal may also be a left or right lane changing signal. In this case, the second execution unit 19 automatically may perform a left or right lane changing operation accordingly in the automatically operated driving mode.

A working process of the second subsystem 102 In other embodiments specifically as follows.

When the mode signal is at the low level, it represents that currently the vehicle is in the manually operated driving mode. The voltage dividing circuit 16 may output an identification voltage signal when identifying that the status signal is at the first voltage of the high level. The second analog-to-digital conversion unit 116 may convert the identification voltage signal into a digital signal, and transmit the digital signal to the voltage control unit 17 by using the first output unit 115. In this case, the voltage control unit 17 may output a second control signal in the first voltage state to the second switch unit 18 according to the identification voltage signal. Under the control of the second control signal, the second switch unit 18 may cause the first connection terminal 181 to be directly electrically connected to the second connection terminal 182, so that the first driving voltage VDD received by the first connection terminal 181 is transmitted to the second execution unit 19 electrically connected to the second connection terminal 182, thereby enabling the second execution unit 19 to perform the first alert operation.

When the mode signal is at the high level, it represents that currently the vehicle is in the automatically operated driving mode. The processing unit 113 may query the storage unit 111 to obtain the status signal, and transmit the status signal to the voltage control unit 17 by using the first output unit 115. In this case, the voltage control unit 17 may output the second control signal in the first voltage state to the second switch unit 18 according to the status signal. Under the control of the second control signal, the second switch unit 18 may cause the first connection terminal 181 to be directly electrically connected to the second connection terminal 182, so that the first driving voltage VDD received by the first connection terminal 181 is transmitted to the second execution unit 19 electrically connected to the second connection terminal 182, thereby enabling the second execution unit 19 to perform the first alert operation.

Corresponding to FIG. 1, an overall connection and a working process of the system 100 for controlling a vehicle in the vehicle (not shown) may be as follows.

First, for the first subsystem 101, the sensor unit 12 may be disconnected from the first execution unit 13, and for the second subsystem 102, the status signal line CA may be electrically disconnected from the second switch unit 18.

Then, the sensor unit 12 may be electrically connected to the first switch unit 14, and the control module 10 may be electrically connected to the first switch unit 14 through the analog unit 15. The first switch unit 14 may be further electrically connected to the first execution unit 13.

The status signal line CA may be electrically connected to the control module 10, and the control module 10 may be correspondingly electrically connected to the second switch unit 18.

During normal operation, according to a current working mode of the vehicle provided by the vehicle control bus, the sensor unit 12 may be correspondingly caused to be electrically connected to the first execution unit 13 through the first switch unit 14, or the control module 10 may be caused to be electrically connected to the first execution unit 13 through the analog unit 15.

In addition, according to the current working mode of the vehicle provided by the vehicle control bus, the control module 10 may output a corresponding control signal to the second switch unit 18 according to a voltage state in the status signal line CA, to provide the first driving voltage VDD to the second execution unit 19 to perform an alert operation, or output a corresponding control signal to the second switch unit 18 to stop providing the first driving voltage VDD to the second execution unit 19 to stop performing an alert operation.

In the automatically operated driving mode, the vehicle may encounter different road conditions including passing and pedestrians during driving, and the system 10 for controlling a vehicle may generate analog signals according to a plurality of pieces of sensor information obtained in advance, to control gears and keep the vehicle driving in a most efficient range.

Compared with the conventional technique, the system 10 for controlling a vehicle in the present disclosure, when executing the automatically operated driving mode, may control each function module of the vehicle without decoding and analyzing information protocols in an operating system of the vehicle, and enable the execution unit in the vehicle to accurately perform a driving operation, thereby simplifying automatically operated driving of the vehicle.

A gear shifting strategy of a conventional vehicle is shown in FIG. 4. FIG. 4 is a schematic flowchart of a conventional gear shifting strategy according to an embodiment of the present disclosure. The gear shifting strategy may include the following three levels. Assuming that measurement parameters are collected, and the measurement parameters may include at least a moving speed of a vehicle, an engine speed, a throttle parameter, and other parameters. In the first level, a gear shifting mode may be used to match a gear shifting characteristic curve. In some exemplary embodiments, the measurement parameters may be analyzed and processed to obtain processed parameters. Analyzing and processing may include summation, filtering, averaging, weighting, and the like. Then, the processed parameters may be used to match a gear shifting characteristic curve. In the second level, a short-time transient response may be performed according to the measurement parameters. In the third level, manual acceleration or deceleration may be responded to according to an engine speed limit. It can be learned that, both the engine speed of the vehicle and the moving speed of the vehicle matches the gear of the vehicle. In other words, if the speed of the vehicle decreases, the gear of the vehicle may be shifted down. If the speed of the vehicle increases, the gear of the vehicle may be shifted up. The conventional gear shifting strategy may have a problem of poor control effect. For example, the vehicle may usually be at a high speed in a high-gear state when the vehicle is currently driving on an uphill road, resulting in a lack of power of the vehicle. Therefore, the gear of the vehicle may need to be shifted down to increase power for passing through the uphill road. According to the conventional gear shifting strategy, the gear of the vehicle may be shifted down only after the moving speed is reduced, resulting in low control efficiency, and causing low traction provided for the vehicle.

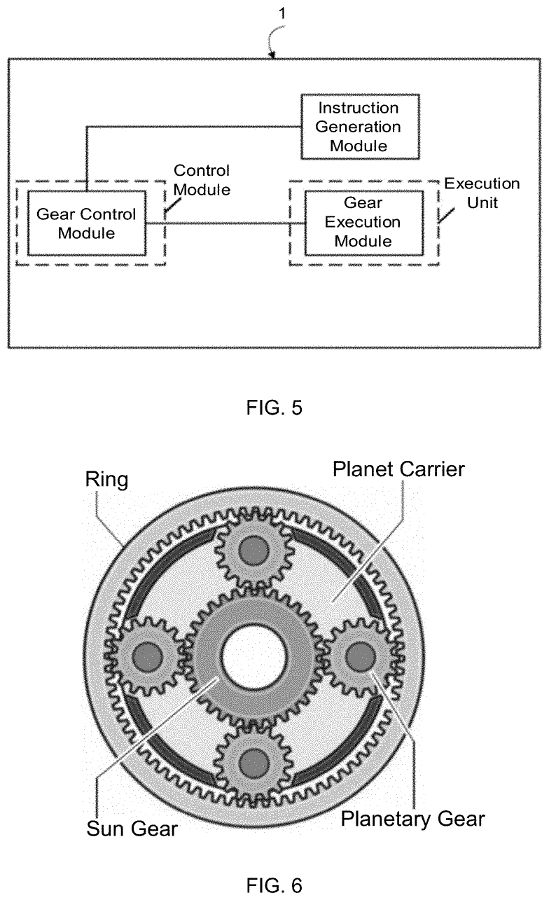

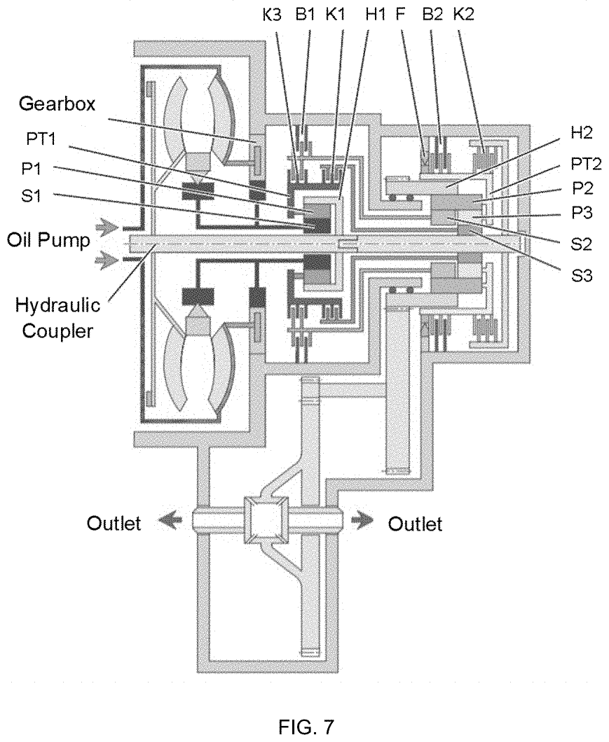

In view of the problem of the existing gear shifting strategy, In some exemplary embodiments of the present disclosure, a gear control module may be added between an instruction generation module and a gear execution module. For a connection relationship between the modules, refer to FIG. 5. FIG. 5 is a function block diagram of a vehicle 1 including a system 100 for controlling a vehicle according to an embodiment of the present disclosure. As shown in FIG. 5, the gear control module may be added between the instruction generation module and the gear execution module to separate gear control from a driving speed of the vehicle, so that the vehicle is in an appropriate gear, thereby improving a vehicle control effect. In some exemplary embodiments, the instruction generation module may be the sensor unit 12 shown in FIG. 1, the gear control module may be the control module 10 shown in FIG. 1, and an executor may be the first execution unit 13 shown in FIG. 1.

In some exemplary embodiments, the control module may obtain a target gear parameter of the vehicle, generate an analog signal (that is, an adjusted operation instruction) according to the target gear parameter, and control the gear of the vehicle according to the analog signal, so that the gear of the vehicle maintains in a most efficient range. In addition, the gear of the vehicle may be directly shifted without a need to wait for a reduction or increase in the moving speed of the vehicle, thereby improving control efficiency.

For example, it is assumed that a current moving speed of the vehicle is 50 km/h. If the control module determines, according to sensor data, that the vehicle is currently on an uphill road, the sensor data may be obtained. The sensor data may include driving environment information. For example, the driving environment information may include slope information. The slope information may be obtained by a video sensor or an inertial measurement unit (IMU). The slope information may include an angle, a length, and the like of the uphill. Further, the control module may determine a target gear of the vehicle according to the current moving speed of the vehicle and the slope information. For example, the target gear may be the first gear. In this case, the control module may shift the gear in the operation instruction to the first gear to obtain an adjusted operation instruction, and send the operation instruction to the gear execution module, without a need to reduce the moving speed of the vehicle. The gear execution module may shift the gear of the vehicle down to the first gear. In this way, the vehicle passes through the uphill in a low gear at a high moving speed. Therefore, the traction for enabling the vehicle to pass through the uphill can be increased, and the vehicle can pass through the uphill more quickly.

For another example, it is assumed that a current moving speed of the vehicle is 10 km/h. If the control module determines, according to sensor data, that the vehicle is currently at a turning point of a road, the sensor data may be obtained. The sensor data may include driving environment information. For example, the driving environment information may include turning information of the turning point. The turning information may be obtained by a video sensor or obtained by an IMU. The turning information may include a turning angle, length, and the like of the turning point. Further, the control module may determine a target gear of the vehicle according to the current moving speed of the vehicle and the turning information. For example, the target gear may be the third gear. In this case, the control module may shift the gear in the operation instruction to the third gear, to obtain an adjusted operation instruction, sends the operation instruction to the gear execution module, without a need to increase the moving speed of the vehicle. The gear execution module may shift the gear of the vehicle up to the third gear. In this way, the vehicle may pass through the turning point in a high gear at a low moving speed. Therefore, the fuel consumption of the vehicle can be reduced, and energy efficiency is higher.

In an embodiment, to support execution of the system 10 for controlling a vehicle, the first execution unit 13 may include a gearbox. FIG. 5 is a schematic structural diagram of a gearbox according to an embodiment of the present disclosure. The gearbox may be implemented by a planetary gear. A central axis of the planetary gear may be a sun gear, surrounded by planetary gears. To hold the planetary gears that rotate around the sun gear, one side of a planet carrier functions as a support to carry the planetary gears, and the other side of the planet carrier performs coaxial power transmission. The outermost ring of the planetary gear may be a ring gear. To improve power transmission capability, some planetary gear sets may be transformed into two sets of pinions to transmit power to each other. One set may be in contact with the sun gear, and the other set may be in contact with the ring gear. This is referred to as a double-pinion planetary gear set.

Further, FIG. 6 is a schematic structural diagram of a connection between an oil pump and a hydraulic coupler in a first execution unit 13 according to an embodiment of the present disclosure. Components may be shown from left to right in FIG. 6 as follows. On the far left may be the hydraulic coupler connected to an engine. Right next to the hydraulic coupler is the oil pump, and then power may be transmitted to a first planetary gear set (that is, the gearbox). As previously mentioned, the gearbox may include a sun gear S1, a planetary gear P1, a planet carrier PT1, and a ring gear H1. On the right side of the gearbox may be a compound planetary gear set. The two planetary gear sets may share a ring gear H2, but respectively have two planetary gears P2/P3, a planet carriers PT2, and a sun gear S2/S3. Brake B1/B2 composed of a plurality of different clutches and clutch K1/K2/K3 may be combined to obtain six forward gears/one reverse gear.

It may be understood that, the foregoing disclosure is merely preferred embodiments of the present disclosure, and should definitely not be used to limit the scope of rights of the present disclosure. A person of ordinary skill in the art may understand that all or some procedures for implementing the foregoing embodiments, and equivalent changes made according to the claims of the present disclosure shall still fall within the protection scope of the present disclosure.

What is claimed is:

1. A system for vehicle control, comprising:
a control module configured to electrically connect to a control bus of a vehicle, the control module including:
one or more storage media storing one or more sets of instructions for controlling a vehicle; and
one or more processors, during operation, to execute the one or more sets of instructions to:
receive a bus signal from the control bus,
query a type of a control signal according to the bus signal, and
convert-to-analog a control output signal for the vehicle according to a result of the query to control a driving state of the vehicle.

2. The system according to claim 1, wherein to convert-to-analog the control output signal for the vehicle according to the result of the query to control the driving state of the vehicle, the one or more processors further execute the one or more sets of instructions during operation to:
generate an analog signal as the output signal according to the result of the query, and
output the analog signal to an execution unit to control the driving state of the vehicle.

3. The system according to claim 2, wherein the analog signal has a same waveform, voltage amplitude, and frequency as the control signal.

4. The system according to claim 3, wherein the control signal includes at least one of a transmitted vehicle sensor signal or a vehicle status signal.

5. The system according to claim 1, wherein during operation, the one or more processor further executes the one or more sets of instructions to: receive a mode signal from the control bus, wherein
the mode signal representing whether the vehicle is in a manually operated driving mode or in an automatically operated driving mode, and
the control bus includes at least one of a status signal bus electrically connected to a vehicle alert module or a sensor bus electrically connected to a sensor unit.

6. The system according to claim 5, wherein the control module prestores a plurality of control signals representing that the vehicle is in different driving states.

7. The system according to claim 6, wherein
the sensor unit includes a first sensor configured to sense one of driving states of the vehicle and output a first sensing signal,
the one or more processors further include an analog control processor configured to generate, according to the first sensing signal, a first analog signal that has a same changing curve as the first sensing signal, and
the execution unit includes a first execution unit, and the control module selectively transmits the first sensing signal or the first analog signal to the first execution unit, to control the first execution unit to perform a first driving operation for the vehicle.

8. The system according to claim 7, wherein during operation, the analog control processor further executes the one or more sets of instructions to:
determine that the vehicle is in the manually operated driving mode, and control the first sensor to electrically connect to the execution unit to make the execution unit, according to the first sensing signal, control the vehicle to be in the manually operated driving mode, and
determine that the vehicle is in the automatically operated driving mode, and control the first analog signal to be transmitted to the execution unit to make the execution unit, according to the first analog signal, control the vehicle to be in the automatically operated driving mode.

9. The system according to claim 7, wherein
the first sensing signal and the first analog signal are two differential signals,
the first sensing signal includes a first sensing differential signal and a second sensing differential signal, and a second voltage range of the second sensing differential signal is greater than and includes a first voltage range of the first sensing differential signal, and
the first analog signal includes a first analog differential signal and a second analog differential signal, the first analog differential signal has a same changing curve as the first sensing differential signal, and the second analog differential signal has a same changing curve as the second sensing differential signal.

10. The system according to claim 9, further comprising:
an analog unit, wherein
the analog control processor further includes a storage unit, a processing unit, and a signal generation unit, the signal generation unit is electrically connected to the storage unit and the signal generation unit, and the signal generation unit is electrically connected to the analog unit,
the storage unit prestores a plurality of first sensing signals,
the processing unit obtains a first sensing signal during the query from the storage unit according to the bus signal, and the signal generation unit outputs a reference signal according to the first sensing signal, and
the analog unit generates the first analog signal according to the reference signal.

11. The system according to claim 10, wherein the signal generation unit is a pulse width modulation circuit, and the reference signal is a pulse width modulation signal output by the pulse width modulation circuit.

12. The system according to claim 11, wherein
the analog unit includes an operational amplifier and an addition operator, the operational amplifier is electrically connected to the signal generation unit, and the addition operator is electrically connected to the operational amplifier,
the operational amplifier receives the pulse width modulation signal, performs operational amplification on the pulse width modulation signal to converts the pulse width modulation signal into an analog voltage signal having the first voltage range, and transmit the analog voltage signal to a first switch unit as the first analog differential signal, and
the addition operator performs an addition operation on the first analog differential signal to obtain another analog voltage signal having the second voltage range as the second analog differential signal.

13. The system according to claim 12, wherein the analog unit further includes a voltage follower, electrically connected to the signal generation unit and the operational amplifier, to perform voltage following on the pulse width modulation signal before the operational amplification is performed on the pulse width modulation signal, so as to isolate the operational amplifier from interference.

14. The system according to claim 10, further comprising:
a first switch unit, electrically connected to the analog unit, the sensor unit, a first execution unit, and the processing unit,
wherein the processing unit outputs a selection signal to the first switch unit according to the bus signal, to control the first switch unit, according to a mode of the vehicle corresponding to the selection signal, to
electrically connect the sensor unit to the first execution unit, or
electrically connect the analog unit to the first execution unit.

15. The system according to claim 14, wherein the first switch unit is a double-pole double-throw relay including
two normally closed input contacts, electrically connected to the first sensor to receive the first sensing differential signal and the second sensing differential signal,
two normally open input contacts, electrically connected to the analog control unit to receive the first analog differential signal and the second analog differential signal, and
two output terminals, being controlled by the selection signal to electrically connect to the first execution unit, to selectively provide the first sensing signal or the first analog signal to the first execution unit.

16. The system according to claim 15, wherein during operation, the analog control processor further executes the one or more sets of instructions to:
determine that the selection signal represents that the vehicle is in the manually operated driving mode, and control the two normally closed input contacts to electrically connect to the two output terminals, to provide the first sensing signal to the first execution unit, and
determine that the selection signal represents that the vehicle is in the automatically operated driving mode, and control the two normally open input contacts to electrically connect to the two output terminals, to provide the first analog signal to the first execution unit.

17. The system according to claim 14, wherein
the first switch unit is a multiway digital switch, including at least two groups of input ports and at least one group of output ports, the at least two groups of input port are not simultaneously electrically connected to the at least one group of output ports,
each group of input ports includes two input ports, and each group of output ports includes two output ports,
two input ports in one group of input ports are electrically connected to the first sensor, to receive the first sensing differential signal and the second sensing differential signal,
two input ports in another group of input ports are electrically connected to the analog control unit, to receive the first analog differential signal and the second analog differential signal, and
during operation, the analog control processor further executes the one or more sets of instructions to control the two input ports to connect to the first execution unit, to selectively provide the first sensing signal or the first analog signal to the first execution unit.

18. The system according to claim 17, wherein during operation, the analog control processor further executes the one or more sets of instructions to:
determine that the selection signal represents that the vehicle is in the manually operated driving mode, and control one group of input ports to electrically connect to the at least one group of output ports, to provide the first sensing signal to the first execution unit, and
determine that the selection signal represents that the vehicle is in the automatically operated driving mode, control another group of input ports to electrically connect to the at least one group of output ports, to provide the first analog signal to the first execution unit.

19. The system according to claim 10, wherein
the analog control processor includes a first mode conversion unit electrically connected to the two normally open input contacts and the processing unit,
the first mode conversion unit is configured to receive the first analog differential signal and the second analog differential signal and perform analog-to-digital conversion to convert the first analog differential signal and the second analog differential signal into digital signals, and
the processing unit is configured to adjust the pulse width modulation signal according to the digital signals, so that each of the first analog differential signal and the second analog differential signal is within a preset range.

20. The system according to claim 19, wherein the first analog-to-digital conversion unit is further electrically connected to the first sensor, to receive the first sensing differential signal and the second sensing differential signal and perform analog-to-digital conversion on the first sensing differential signal and the second sensing differential signal, and
the processing unit is configured to determine a state of a first driving module according to the first sensing differential signal and the second sensing differential signal on which the analog-to-digital conversion processing has been performed, and
during operation, the analog control processor further executes the one or more sets of instructions to performs an operation in the automatically operated driving mode or exits the automatically operated driving mode according to the state of the first driving module.
